(19) United States
(12) Patent Application Publication
(10) Pub. No.: US 2014/0218923 A1
(43) Pub. Date: Aug. 7, 2014

(54) LED BULB HAVING CONNECTING ANGLE ADJUSTABLE

(71) Applicant: THE LIGHT OF THE WORLD INTERNATIONAL CO., LTD, Kaohsiung City (TW)

(72) Inventor: Po Wen CHI, Kaohsiung City (TW)

(21) Appl. No.: 13/906,620

(22) Filed: May 31, 2013

(30) Foreign Application Priority Data
Feb. 7, 2013 (TW) 102202840

(51) Int. Cl. F21K 99/00

(52) U.S. Cl. CPC F21K 9/50
USPC 362/249.03

(57) ABSTRACT

Disclosed is a LED bulb comprises a bulb body, a bulb cap and an angle adjusting means. The angle adjusting means includes a first ratchet member fixed to the bulb and a second ratchet member fixed to the bulb cap. The first ratchet member and the second ratchet member are rotatable on a rotation axis, and the first ratchet member and the second ratchet member are engaged with each other at an adjusted position angle to emit the light in an emitting direction from the emitting plane with respect to the bulb cap. Accordingly, it provides an adjustable connecting angle between the bulb body and the bulb cap to thus adjust the emitting plane of the bulb body to a desired direction to overcome the problems in the conventional art.

### CROSS-REFERENCE TO RELATED APPLICATION

This application claims priority to Taiwanese Patent Application No. 102202840, filed Feb. 7, 2013, which is hereby incorporated by reference.

### FIELD OF THE INVENTION

The present invention relates to a LED bulb, and more particularly to a LED bulb having connecting angle which is adjustable.

### BACKGROUND OF THE INVENTION

A conventional light bulb, which is provided with a screw-shape connector, is screwed with the screw-shape connector into a lamp holder, which is provided with a corresponding screw-shape connector, of the lamp to thus emit the light. The conventional light bulb emits the light in all directions, i.e., all angles, so that a mounted angle between the light bulb and the lamp holder is not of consideration.

A light-Emitting Diode (LED), which is a semiconductor electric component, is lighted by transferring electrical energy into energy in form of light. A LED bulb has advantages of high luminous efficiency, long life period, strong structure and fast speed of operation, and is thus gradually replaced the conventional light lamp.

The LED bulb is made by forming LEDs on a circuit board, where the numbers of the LEDs are determined in accordance with the necessity of brightness. The LEDs are thus arranged on the circuit board to form a single emitting plane to emit light from the circuit board. However, in order to screw the LED bulb to the lamp holder tightly, it is necessary to consider the corresponding end position of the screw-shape connector of the LED bulb and the corresponding screw-shape connector of the lamp holder. If the end positions thereof do not properly match with each other, the single emitting plane may face toward a wrong direction if the tight connection is required. Thereafter, the wrong direction of the single emitting plane will cause a light to project to a wrong place. Moreover, a LED bulb will often meet a situation that it is difficult to adjust a specific lighting angle, if it is desired. Accordingly, it is an issue to solve the above problems.

### SUMMARY OF THE INVENTION

Accordingly, an aspect of the present invention is for providing a LED bulb having connecting angle adjustable.

The LED bulb includes a bulb body, a bulb cap and an angle adjusting means. The bulb body includes a LED module, and the LED module includes a circuit board and at least one LED provided on the circuit board in such a manner that an emitting plane is formed. The bulb cap is electrically connected with the LED module. The angle adjusting means includes a first ratchet member fixed to the bulb and a second ratchet member fixed to the bulb cap. The first ratchet member and the second ratchet member are rotatable on a rotation axis, and the first ratchet member and the second ratchet member are engaged with each other at an adjusted position angle to emit the light in an emitting direction from the emitting plane with respect to the bulb cap.

In a preferred embodiment of the present invention, the first ratchet member and the second ratchet member both have a plurality of tooth parts and a plurality of recess parts formed between the adjacent two tooth parts, the tooth parts and the recess parts are provided to generate a plurality of distribution position angles on an engagement surface, and the first ratchet member and the second ratchet member are engaged with each other and positioned at one of the adjusted position angles.

In a preferred embodiment of the present invention, the tooth parts are provided protruding toward a direction parallel to the rotation axis.

In a preferred embodiment of the present invention, the tooth parts are provided protruding toward a direction perpendicular to the rotation axis.

In a preferred embodiment of the present invention, the engagement surface is formed in shape of a circular.

In a preferred embodiment of the present invention, the angle adjusting means includes a come-off preventing member connected between the first ratchet member and the second ratchet member.

In a preferred embodiment of the present invention, the bulb cap is provided at an outer peripheral edge thereof with a thread.

In a preferred embodiment of the present invention, the LED module is provided with a heat sink on a side of the circuit board.

In a preferred embodiment of the present invention, it further includes a tin layer or a graphite layer provided between the heat sink and the circuit board.

In a preferred embodiment of the present invention, the heat sink is a metal heat sink.

By means of technical means of the present invention, it provides an adjustable connecting angle between the bulb body and the bulb cap to thus adjust the emitting plane of the bulb body to a desired direction to overcome the problems in the conventional art.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is an explosion diagram illustrating a LED bulb of the first embodiment according to the present invention;

FIG. 2 is a cross-section view illustrating an angle adjusting means of the first embodiment according to the present invention;

FIG. 3 and FIG. 4 are adjustment schematic diagrams illustrating the angle adjustment of the LED bulb of the first embodiment according to the present invention; and

FIG. 5 is an explosion diagram illustrating a LED bulb of the second embodiment according to the present invention.

### DETAILED DESCRIPTION OF THE PREFERRED EMBODIMENTS

### The First Embodiment

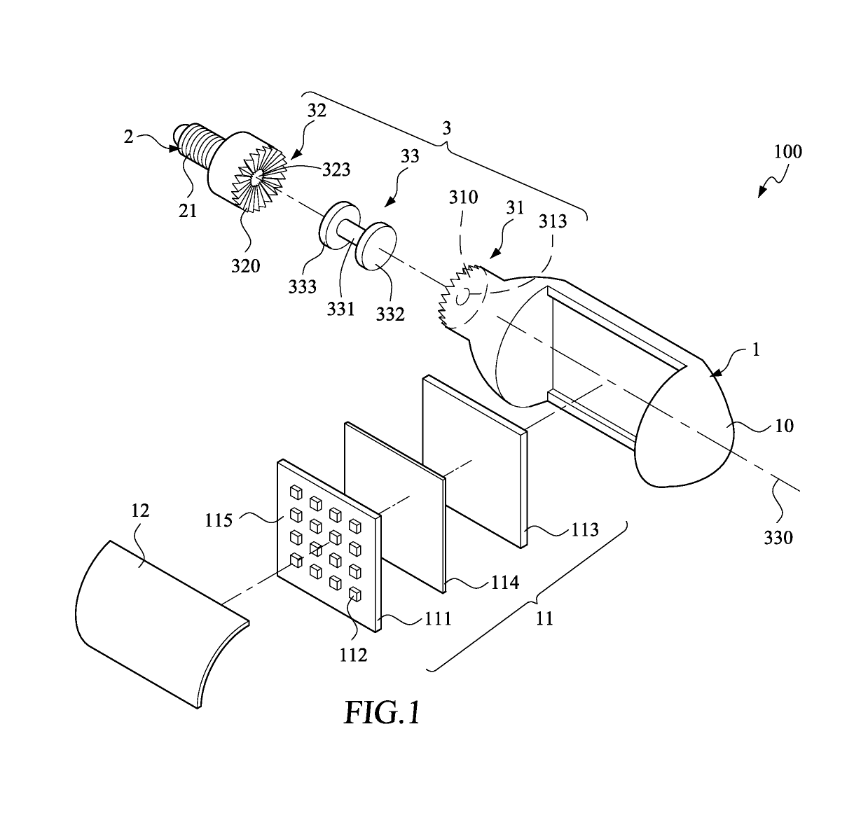

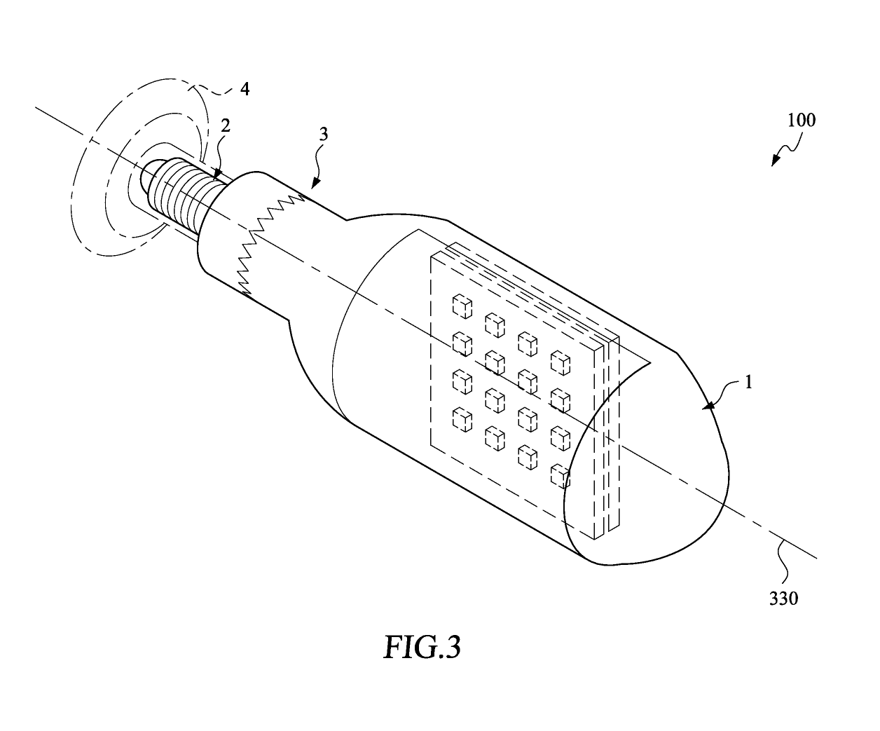

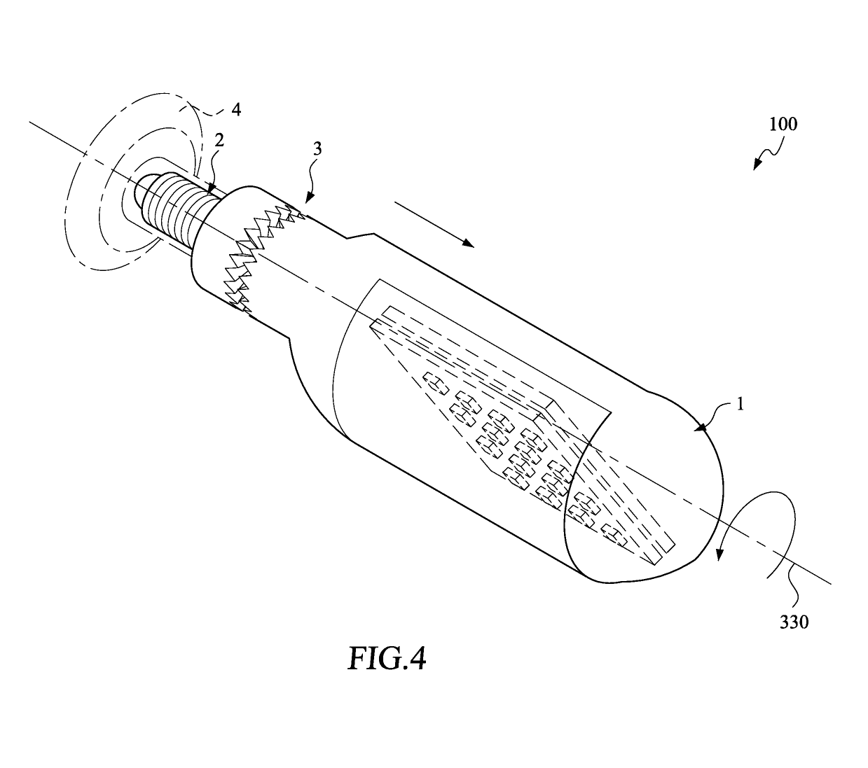

Refer to FIG. 1 to FIG. 4. A LED bulb 100 of the first embodiment of the present invention includes a bulb body 1, a bulb cap 2 and an angle adjusting means 3.

The bulb body 1 includes a bulb body 10, a LED module 11 and a bulb shade 12. The LED module 11 is provided on the bulb body 10 and is electrically connected with the bulb cap 2. The LED module 11 includes a circuit board 111, LEDs 112, a heat sink 113 and a thermal conducting layer 114. In the embodiment, the LEDs 112 are provided on one side of the circuit board 111 to emit light from the circuit board 111 in such a manner that an emitting plane 115 is formed. The heat sink 113 is provided on the other side of the circuit board 111, and the thermal conducting layer 114 is provided between the circuit board 111 and the heat sink 113. In the embodiment, the heat sink 113 is a metal heat sink, and may be an aluminum heat sink in other embodiments. However, the present invention is not limited to this, and the heat sink may be provided with cooling fins to enhance the cooling efficiency. The thermal conducting layer 114 is a tin layer to solder the heat sink 113 to the circuit board 111, and thus it provides secure combination between the circuit board 111 and the heat sink 113 as well as better cooling efficiency. Besides, in the other embodiment, the thermal conducting layer 114 is a graphite layer, and is fixed to the circuit board 111 and the heat sink 113 by screws and nuts. The bulb shade 12 covers on the emitting plane 115 to diffuse the light from the emitting plane 115 to increase an illumination angle or to soften the light.

The bulb cap 2 is provided at an outer peripheral edge thereof with a thread 21 for screwing the bulb holder 4 in such a manner to receive the outer power and make the LEDs emit the light. Of course, the present invention is not limited to this. A bulb cap which is fixed to a bulb holder with a two-pin connector is also suitable.

The angle adjusting means 3 includes a first ratchet member 31, a second ratchet member 32 and a come-off preventing member 33. The first ratchet member 31 is fixed to an end of the bulb body 1 and the second ratchet member 32 is fixed to an end of the bulb cap 2. The first ratchet member 31 has a first engagement surface 310 formed with fist tooth parts 311 and first recess parts 312, and each of the first recess parts 312 is formed between the adjacent two first tooth parts 311. Similarly, the second ratchet member 32 has a second engagement surface 320 formed with second tooth parts 321 and second recess parts 322, and each of the second recess parts 322 formed between the adjacent two second tooth parts 321. Further, the first ratchet member 31 has a first hole 313, and the second ratchet member 32 has a second hole 323 communicated with the first hole 313.

The come-off preventing member 33 includes a rotating shaft 331 and two stopping parts 332 and 333. The rotating shaft 331 has a rotation axis 330 parallel to the emitting plane 115. A length of the rotating shaft 331 is longer than the total depth of the first hole 313 and the second hole 323. The rotating shaft 331 is sleeved within the first hole 313 and the second hole 323, and both ends of the rotating shaft 331 are fixed with the stopping parts 332 and 333 to prevent the rotating shaft to come off from the first hole 313 and the second hole 323. In such a structure, a distance between the first ratchet member 31 and the second ratchet member 32 is adjustable along the rotation axis 330, and the first ratchet member 31 and the second ratchet member 32 will not depart from the rotating shaft 331. And, the first ratchet member 31 and the second ratchet member 32 are rotatable to the rotating shaft 331 on the rotation axis 330.

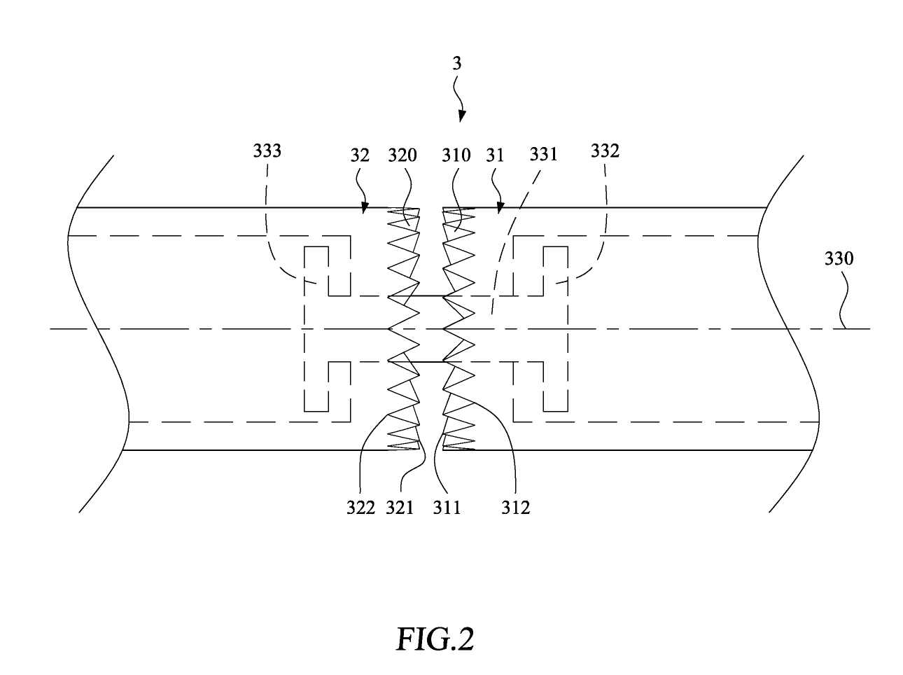

Referring to FIG. 2, the fist tooth parts 311 and the first recess parts 312 are provided to thus generate a plurality of distribution position angles on the first engagement surface 310. The second tooth parts 321 and the second recess parts 322 are provided to generate a plurality of distribution position angles on the second engagement surface 320. Hence the first ratchet member 31 and the second ratchet member 32 are engaged with each other at a position which is one of a plurality of adjusted position angles, which is adjustable. In the embodiment, the first tooth parts 311 and the second tooth parts 321 both are provided protruding in a direction parallel to the rotation axis as shown in FIGS. 1 and 2. Both the first engagement surface 310 and the second engagement surface 320 are formed in shape of a circular. The first ratchet member 31 has twenty four first tooth parts 311. The second ratchet member 32 has twenty four second tooth parts 321. The tooth parts 311 and 321 are distributed around the rotation axis 330 as center, and a central angle between the adjacent tooth parts 311 and 321 is fifteen degrees. Each fist tooth part is capable of being engaged with any one of the second recess part 322, and each first recess part 312 is capable of engaged with any one of the second tooth parts 321. Consequently, after the first ratchet member 31 is rotated fifteen degrees with respect to the second ratchet member 32 on the rotation axis 330, the first ratchet member 31 will be engaged with the second ratchet member 32 in the next position angle. In the embodiment, there are twenty four position angles between the first ratchet member 31 and the second ratchet member 32.

The bulb cap 2, which is connected with the bulb body 1, is rotated and screwed to the bulb holder 4, after the first ratchet member 31 and the second ratchet member 32 are engaged with each other. After screwed, the bulb body 1 is pulled out along the direction parallel to the rotation axis to separate the first ratchet member 31 from the second ratchet member 32. Accordingly, the pulled bulb body 1 is positioned to a position angle, which is a desired angle of the emitting plane 115, and is pushed back so that the first ratchet member 31 and the second ratchet member 32 are engaged with each other. The bulb body 1 is pushed back to the bulb cap 2 along the direction parallel to the rotation axis. As a result, the emitting direction of the emitting plane 115 is adjusted to a desired direction.

### Second Embodiment

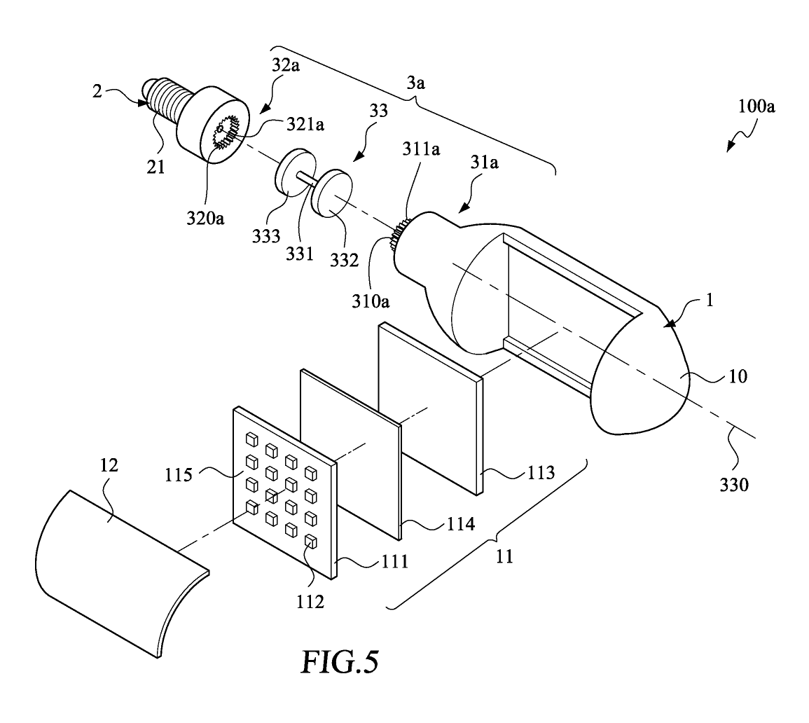

Refer to FIG. 5. A LED bulb 100a of the second embodiment of the present invention includes first tooth parts 311a and second tooth parts 321a, which both are provided protruding in a direction perpendicular to the rotation axis 330, which means that the first tooth parts 311a and the second tooth parts 321a both are provided protruding along a radial direction of the rotation axis 330. In other words, a first engagement surface 310a of a first ratchet member 31a is surrounded by a second engagement surface 320a of a second ratchet member 32a. Of course, the present invention is not limited to this, and a second engagement surface of a second ratchet member is surrounded by a first engagement surface of a first ratchet member in other embodiment.

The above description should be considered as only the discussion of the preferred embodiments of the present invention. However, a person skilled in the art may make various modifications to the present invention. Those modifications still fall within the spirit and scope defined by the appended claims.

What is claimed is:

1. A LED bulb comprising:
a bulb body including a LED module, the LED module including a circuit board and at least one LED provided on the circuit board in such a manner that an emitting plane is formed;
a bulb cap electrically connected with the LED module; and
an angle adjusting means including a first ratchet member fixed to the bulb body and a second ratchet member fixed to the bulb cap, the first ratchet member and the second ratchet member being rotatable on a rotation axis, the first ratchet member and the second ratchet member being engaged with each other at an adjusted position angle to emit the light in an emitting direction from the emitting plane with respect to the bulb cap.

2. The LED bulb as claimed in claim 1, wherein the first ratchet member and the second ratchet member both have a plurality of tooth parts and a plurality of recess parts formed between the adjacent two tooth parts, the tooth parts and the recess parts are provided to generate a plurality of distribution position angles on an engagement surface, and the first ratchet member and the second ratchet member are engaged with each other and positioned at one of the adjusted position angles.

3. The LED bulb as claimed in claim 2, wherein the tooth parts are provided protruding toward a direction parallel to the rotation axis.

4. The LED bulb as claimed in claim 2, wherein the tooth parts are provided protruding toward a direction perpendicular to the rotation axis.

5. The LED bulb as claimed in claim 2, wherein the engagement surface is formed in shape of a circular.

6. The LED bulb as claimed in claim 1, wherein the angle adjusting means includes a come-off preventing member connected between the first ratchet member and the second ratchet member.

7. The LED bulb as claimed in claim 1, wherein the bulb cap is provided at an outer peripheral edge thereof with a thread.

8. The LED bulb as claimed in claim 1, wherein the LED module is provided with a heat sink on a side of the circuit board.

9. The LED bulb as claimed in claim 8, further comprising a tin layer or a graphite layer provided between the heat sink and the circuit board.

10. The LED bulb as claimed in claim 8, wherein the heat sink is a metal heat sink.
